(19) United States
(12) Patent Application Publication
(10) Pub. No.: US 2026/0204146 A1
(43) Pub. Date: Jul. 16, 2026

(54) SUCTION DEVICE AND SUCTION SYSTEM

(71) Applicant: JVCKENWOOD Corporation, Yokohama-shi (JP)

(72) Inventors: Miku KOMURATA, Yokohama-shi (JP); Takao Sato, Yokohama-shi (JP)

(21) Appl. No.: 19/566,084

(22) Filed: Mar. 13, 2026

Related U.S. Application Data
(63) Continuation of application No. PCT/JP2024/036087, filed on Oct. 9, 2024.

(30) Foreign Application Priority Data
Oct. 13, 2023 (JP) 2023-177451
Aug. 26, 2024 (JP) 2024-144204
Aug. 30, 2024 (JP) 2024-148599

(51) Int. Cl. G08B 13/14; F16B 47/00

(52) U.S. Cl. CPC G08B 13/1436; F16B 47/00

(57) ABSTRACT

A suction device includes a firmly-fixing part used to firmly fix a suction device to a mobile device, a suction part used to make the suction device stick by suction to an object, a theft determination unit configured to determine whether or not the mobile device is in a stolen state based on a sticking state of the suction part, and a notification control unit configured to send a notification when it is determined that the mobile device is in a stolen state.

### CROSS REFERENCE TO RELATED APPLICATION

This application is a bypass continuation application of International Patent Application No. PCT/JP2024/036087, filed on October 9, 2024, which is based upon and claims the benefit of priority from Japanese patent application No. 2023-177451, filed on October 13, 2023, Japanese patent application No. 2024-144204, filed on August 26, 2024, and Japanese patent application No. 2024-148599, filed on August 30, 2024, the disclosures of which are incorporated herein in their entirety by reference.

### BACKGROUND

The present disclosure relates to a suction device and a suction system.

In recent years, a working style of remote work, in which a person works at a place other than a company by using a mobile device such as a notebook PC, has become widespread. A user of a mobile device can carry a mobile device to a store such as a cafe or a coworking space and work there. A user may be away from the mobile device when the user leave his/her seat temporarily for a break or the like. Techniques for preventing theft of a mobile device in such a case are known. For example, security wires are generally used to prevent theft of notebook PCs. A user winds a wire around something that cannot be easily moved, such as a desk leg, and attaches a metal fitting at the end of the wire to a hole referred to as a security slot provided in a notebook PC. The user can take anti-theft measures by performing locking using a dial lock or the like provided in the metal fitting.

Further, as related art, Patent Literature 1 discloses a vehicle-mounted information processing apparatus including a suction unit formed by a plurality of suction bodies in each of which the inside thereof is brought into a negative pressure state. In the vehicle-mounted information processing apparatus, when a suction unit ON switch is pressed, the inside of the suction body is brought into a negative pressure state, and the main body sticks by suction to a suction target surface (e.g., a dashboard) in the vehicle. This configuration prevents a person other than a user from removing the vehicle-mounted information processing apparatus from the suction target surface.

Patent Literature 1 Japanese Unexamined Patent Application Publication No. 2000-079854

### SUMMARY

Even in a case where a mobile device is fixed to a predetermined object when a user leaves his/her seat by using the above-described technique, the mobile device may be forcibly removed from the object by a third person.

A suction device according to the present disclosure includes:

a firmly-fixing part used to firmly fix a suction device to a mobile device;

a suction part used to make the suction device stick by suction to an object;

a theft determination unit configured to determine whether or not the mobile device is in a stolen state based on a sticking state of the suction part; and

a notification control unit configured to send a notification when it is determined that the mobile device is in a stolen state.

A suction system according to the present disclosure includes:

a mobile device; and

a suction device configured to make the mobile device stick by suction to an object,

in which the suction device comprises:

a firmly-fixing part used to firmly fix the suction device to the mobile device;

a suction part used to make the suction device stick by suction to the object;

a theft determination unit configured to determine whether or not the mobile device is in a stolen state based on a sticking state of the suction part; and

a notification control unit configured to send a notification when it is determined that the mobile device is in a stolen state.

A suction device according to the present disclosure includes:

a firmly-fixing part used to firmly fix a suction device to a mobile device;

a suction part used to make the suction device stick by suction to an object;

a theft determination unit configured to determine whether or not the mobile device is in a stolen state based on a sticking state of the suction part; and

a communication unit configured to notify a terminal apparatus that the mobile device is in a stolen state through the mobile device when it is determined that the mobile device is in a stolen state.

### BRIEF DESCRIPTION OF THE DRAWINGS

The above and other aspects, advantages and features will be more apparent from the following description of certain embodiments taken in conjunction with the accompanying drawings, in which:

FIG. 1 is a diagram showing an overall configuration of a suction system according to a first embodiment;

FIG. 2 is a perspective view showing an example of the appearance of the suction system according to the first embodiment;

FIG. 3 is a diagram showing the suction system shown in FIG. 2 as viewed from the back surface thereof;

FIG. 4 is a perspective view showing an example of the appearance of a suction device according to the first embodiment;

FIG. 5 is a block diagram showing in detail a configuration of the suction system according to the first embodiment;

FIG. 6 is a flowchart showing processes performed by the suction device according to the first embodiment;

FIG. 7 is a diagram showing an overall configuration of a suction system according to a third embodiment;

FIG. 8 is a block diagram showing in detail a configuration of the suction system according to the third embodiment;

FIG. 9 is a diagram showing an overall configuration of a suction system according to a fourth embodiment;

FIG. 10 is a block diagram showing in detail a configuration of the suction system according to the fourth embodiment;

FIG. 11 is a diagram showing an overall configuration of a suction system according to a fifth embodiment; and

FIG. 12 is a block diagram showing in detail a configuration of the suction system according to the fifth embodiment.

### DETAILED DESCRIPTION

Embodiments of the present disclosure will be described hereinafter in detail below with reference to the drawings. The same or corresponding elements are denoted by the same reference symbols throughout the drawings. Redundant descriptions will be omitted as necessary for the clarification of the description.

### First Embodiment

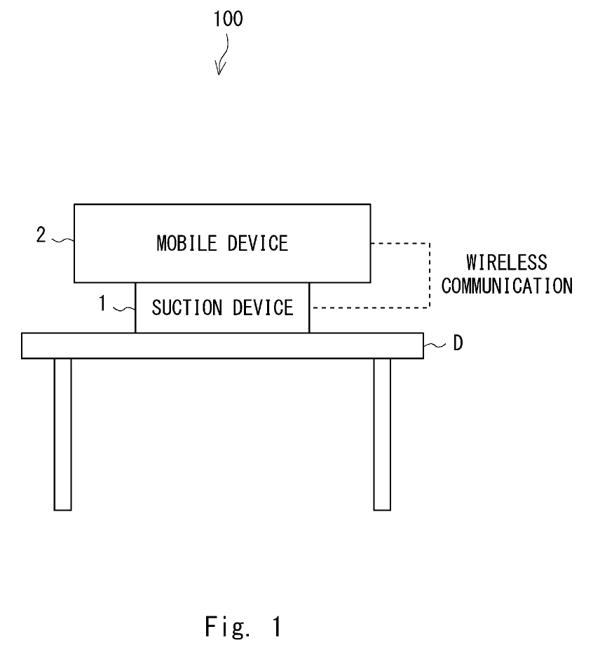

First, a suction system 100 according to a first embodiment will be described. FIG. 1 is a diagram showing an overall configuration of the suction system 100 according to this embodiment.

### Suction System 100

An outline of a system configuration of the suction system 100 will be described. The suction system 100 includes a suction device 1 and a mobile device 2. The mobile device 2 is a device to be prevented from theft. The mobile device 2 is, for example, a notebook PC, a tablet, or a smartphone. The mobile device 2 is not limited to these devices, and may instead be a device of various kinds.

The suction device 1 is a device for making the mobile device 2 stick by suction to an object. The suction device 1 and the mobile device 2 are firmly fixed to each other. The suction device 1 sticks by suction to an object, so that the mobile device 2 sticks by suction to the object through the suction device 1.

The object indicates a subject to which the mobile device 2 is made to stick by suction through the suction device 1. For example, the object has a shape allowing the mobile device 2 to be placed thereon. The object may be furniture or equipment provided in an environment where the mobile device 2 is used. The object may be, for example, a desk or a table. The object is not limited to these objects, and may instead be an object that makes it difficult to carry the mobile device 2 when it is made to stick by suction thereto. The object may be a wall surface to which the mobile device 2 is made to stick by suction. In this example, a desk D shown in the figure is used as an example of the object.

The suction device 1 and the mobile device 2 are firmly fixed to each other in advance by some method so that they cannot be easily removed from each other. When the suction system 100 is used, wireless communication is performed between the suction device 1 and the mobile device 2. Note that wired communication may be performed instead of wireless communication.

The mobile device 2 controls a sticking operation of the suction device 1. The sticking operation indicates an operation in which the suction device 1 sticks by suction to the desk D. The mobile device 2 controls the start and the end of the sticking by suction to the desk D in the suction device 1. In the following description, the start of the sticking by suction may be indicated by "ON" of the sticking operation, and the end of the sticking by suction may be indicated by "OFF" of the sticking operation.

It is assumed that the mobile device 2 turns ON the sticking operation while the suction device 1 is not sticking by suction to the desk D. In this case, the suction device 1 starts sticking by suction to the desk D. The suction device 1 continues sticking by suction to the desk D until the sticking operation is turned OFF. Thus, the suction device 1 is brought into a state in which it is firmly fixed to the desk D. When the sticking operation is turned OFF, the suction device 1 ends sticking by suction to the desk D. Thus, the suction device 1 is brought into a state in which it is not firmly fixed to the desk D. In this way, the suction device 1 starts and ends sticking by suction to the desk D by turning ON/OFF the sticking operation. By the above configuration, the suction device 1 and the mobile device 2 can be firmly fixed to the desk D temporarily.

It is assumed that, when the suction system 100 is used, a user who is an owner of the suction device 1 and the mobile device 2 leaves his/her seat temporarily. At this time, the mobile device 2 turns ON the sticking operation of the suction device 1 to firmly fix the suction device 1 to the desk D. Further, the mobile device 2 is brought into a state in which a third person other than the user cannot operate the mobile device 2.

It is assumed that, while the suction device 1 is sticking by suction to the desk D, the sticking of the suction device 1 is about to be forcibly removed. In this case, the suction device 1 detects that the sticking of the suction device 1 is about to be forcibly removed by a sensor or the like and issues an alert sound or the like to its surroundings. By doing so, it is possible to prevent a third person from turning OFF the sticking operation of the suction device 1.

As described above, the suction device 1 itself does not perform the ON/OFF control of the sticking operation. Further, when the sticking is about to be forcibly removed, the suction device 1 issues an alert. By this configuration, the suction system 100 makes it difficult for a third person to take the mobile device 2 away.

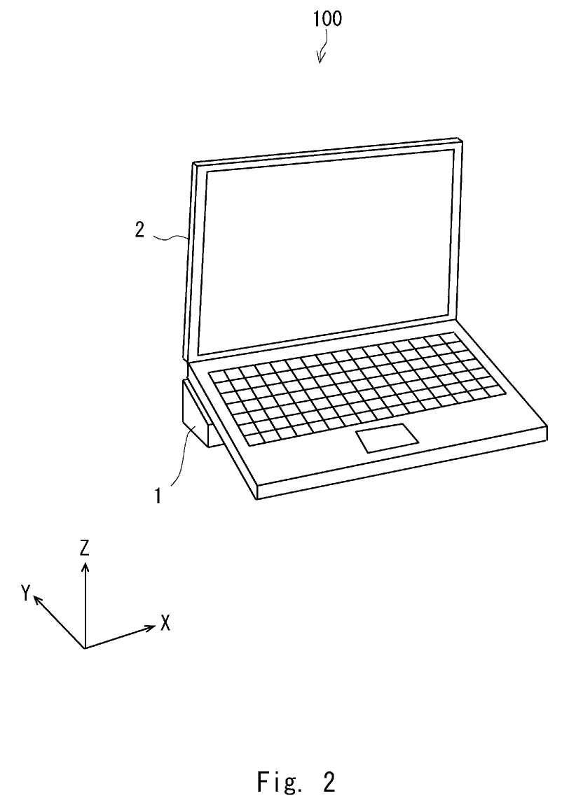

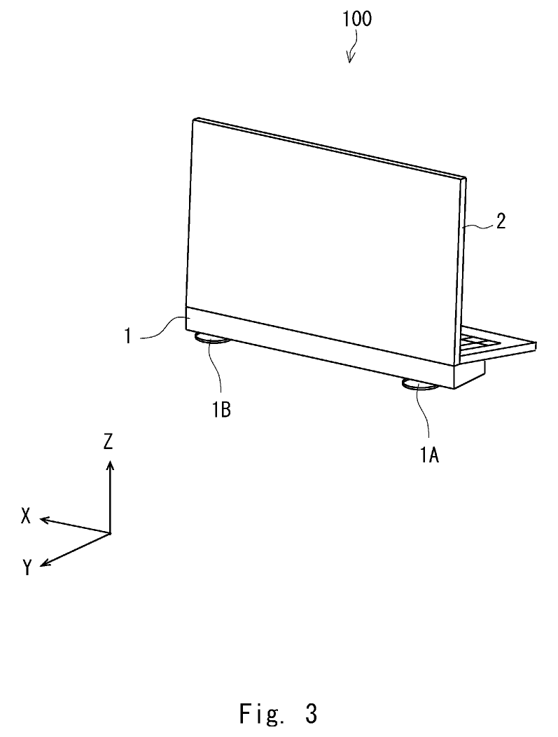

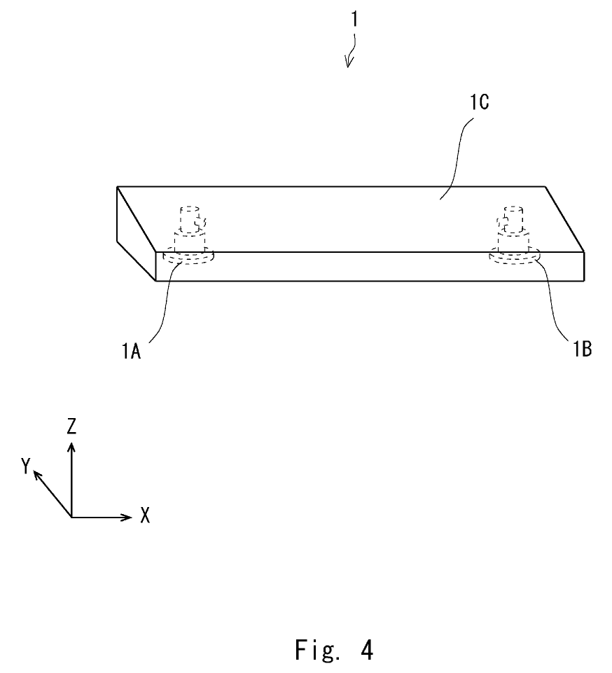

Specific examples of the suction system 100 will be described with reference to FIGS. 2 to 4. FIG. 2 is a perspective view showing an example of the appearance of the suction system 100. FIG. 3 is a diagram showing the suction system 100 shown in FIG. 2 as viewed from the back surface thereof. FIG. 4 is a perspective view showing an example of the appearance of the suction device 1.

A three-dimensional coordinate system is also shown in each of FIGS. 2 to 4 for convenience of explanation. The X-axis direction indicates the width direction of each of the suction device 1 and the mobile device 2. The Y-axis direction indicates the depth direction of each of the suction device 1 and the mobile device 2. The Z-axis direction indicates the height direction of each of the suction device 1 and the mobile device 2. The top plate of the desk D on which the suction device 1 and the mobile device 2 are placed is substantially parallel to the XY plane. Therefore, the contact surface between the suction device 1 and the desk D is substantially parallel to the XY plane.

As shown in FIGS. 3 and 4, the suction device 1 includes suction pads 1A and 1B which stick by vacuum suction to the desk D. Further, the suction device 1 also includes a vacuum pump (not shown). The vacuum pump evacuates air between the desk D and each of the suction pads 1A and 1B, so that the suction device 1 is made to stick by suction to the desk D.

The number of suction pads provided in the suction device 1 is not limited to two. The number of suction pads may be any integer equal to or greater than one. Similarly, the number of vacuum pumps may be any integer equal to or greater than one. The suction device 1 may be configured so that one vacuum pump evacuates air in a plurality of suction pads. Further, the suction device 1 may include vacuum pumps respectively corresponding to a plurality of suction pads.

Further, as shown in FIG. 4, a firmly-fixing surface 1C for firmly fixing the suction device 1 to the mobile device 2 may be provided so as to be inclined with respect to the XY plane. Specifically, the firmly-fixing surface 1C may be provided in such a manner that the rear side thereof becomes higher (the front side thereof becomes lower) as viewed from a user. By providing the firmly-fixing surface 1C with an inclination in this manner, a user can easily type the keyboard of the mobile device 2. The present disclosure is not limited thereto, and the firmly-fixing surface 1C may be provided substantially horizontally with respect to the desk D.

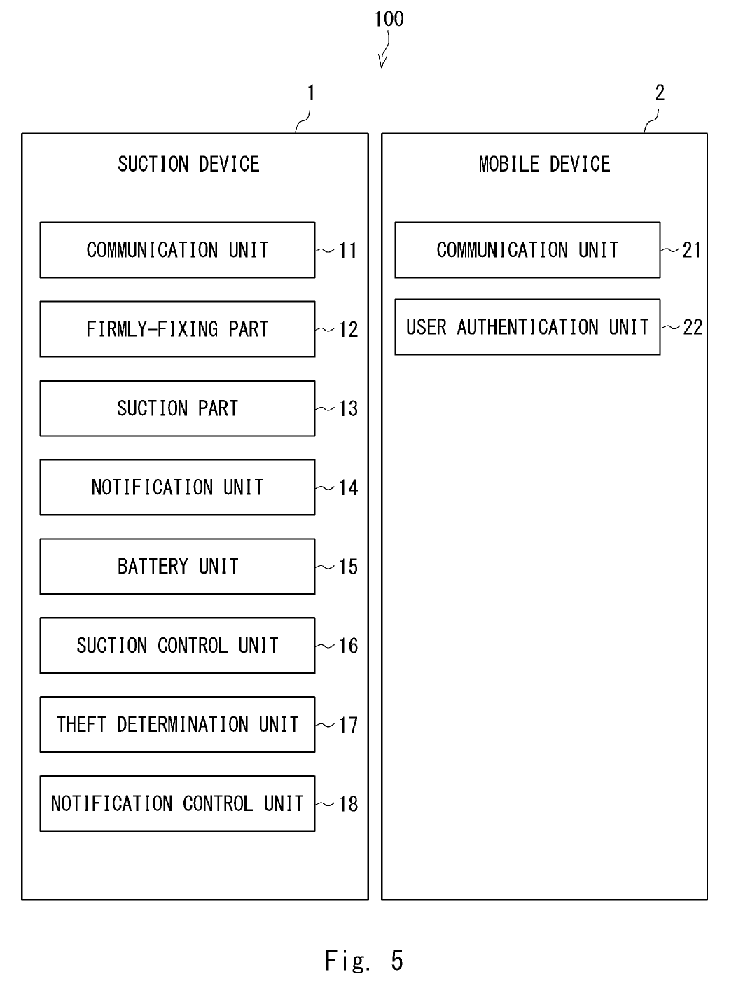

Next, a configuration of the suction system 100 will be described in detail with reference to FIG. 5. FIG. 5 is a block diagram showing in detail the configuration of the suction system 100. In this embodiment, a description will be given of an example in which the suction device 1 sticks by suction to the desk D using an electrically-driven suction pad. Further, a notebook PC will be used as an example of the mobile device 2. The mobile device 2 controls the suction device 1 to make the suction device 1 stick by suction to the desk D. Thus, the suction device 1 and the mobile device 2 stick by suction to the desk D.

### Suction Device 1

The suction device 1 includes a communication unit 11, a firmly-fixing part 12, a suction part 13, a notification unit 14, a battery unit 15, a suction control unit 16, a theft determination unit 17, and a notification control unit 18.

The suction device 1 includes, as components that are not shown, a processor, a memory, and a storage device. The storage device stores a computer program in which processing according to this embodiment is implemented. The processor may load the computer program from the storage device into the memory and execute the loaded computer program. In this way, the processor implements the functions of the suction control unit 16, the theft determination unit 17, and the notification control unit 18.

Each of the suction control unit 16, the theft determination unit 17, and the notification control unit 18 may be implemented by dedicated hardware. Further, some or all of the components may be implemented by a general-purpose or dedicated circuitry, a processor, etc., or a combination thereof. These components may be formed by a single chip or by a plurality of chips connected to each other through a bus. Some or all of the components may be implemented by a combination of the above-mentioned circuitry etc. and a program. Further, a Central Processing Unit (CPU), a Graphics Processing Unit (GPU), a Field-Programmable Gate Array (FPGA), a quantum processor (a quantum computer control chip), or the like may be used as the processor.

Further, when some or all of the components are implemented by a plurality of information processing apparatuses, circuits, etc., the plurality of information processing apparatuses, the circuits, etc. may be disposed in one place in a concentrated manner or disposed in a discrete manner. For example, the information processing apparatuses, the circuits, etc. may be implemented in the form of a client server system, a cloud computing system, or the like in which the information processing apparatuses, the circuits, etc. are connected to each other through a communication network.

The communication unit 11 communicates with the mobile device 2. The communication unit 11 is a communication interface for performing wireless communication by a communication scheme such as Bluetooth (registered trade mark; the same applies hereinafter), Near Field Communication (NFC), or Wi-Fi (registered trademark). An example in which Bluetooth is used will be described below.

The communication unit 11 may be a communication interface for performing wired communication with the mobile device 2. For example, the communication unit 11 includes a terminal for connecting the suction device 1 to the mobile device 2 through a wire. When the communication unit 11 communicates with the mobile device 2 using a Universal Serial Bus (USB) cable or the like, the cable may be pulled out by a third person. Therefore, it is desirable that the communication unit 11 perform wired communication in such a manner that it is not visually recognized from the outside.

The firmly-fixing part 12 is used to firmly fix the suction device 1 to the mobile device 2. The firmly-fixing part 12 is provided, for example, on a contact surface with the mobile device 2. The contact surface with the mobile device 2 may be the upper surface of the suction device 1. For example, the firmly-fixing part 12 firmly fixes the bottom surface of the mobile device 2 to the upper surface of the suction device 1.

The firmly-fixing part 12 firmly fixes the suction device 1 to the mobile device 2, for example, by using a double-sided tape or an adhesive on the contact surface with the mobile device 2. As the double-sided tape or the adhesive, one that enables the suction device 1 and the mobile device 2 to be strongly and firmly fixed to each other in such a manner that a third person cannot easily remove the mobile device 2 from the suction device 1 is used. The firmly-fixing force in the firmly-fixing part 12 is stronger than the maximum suction force of the suction part 13.

Another suction part 13 may be added to the suction device 1, and the added suction part 13 may be configured as the firmly-fixing part 12. The firmly-fixing part 12 may firmly fix the suction device 1 to the mobile device 2 by making the added suction part 13 always stick by suction to the mobile device 2.

Further, the mobile device 2 may be configured so that it includes the suction device 1 therein. In this case, the firmly-fixing part 12 is configured to firmly fix the suction device 1 to the mobile device 2 in the manufacturing stage.

The suction part 13 is used to make the suction device 1 stick by suction to the desk D. The suction part 13 makes the suction device 1 stick by suction to the desk D in accordance with the control of the suction control unit 16. The suction part 13 includes a suction pad which sticks by vacuum suction to the desk D on the contact surface with the desk D. Further, the suction part 13 includes a vacuum pump for evacuating air in the suction pad and a vacuum sensor for measuring the degree of vacuum in the suction pad.

The vacuum pump evacuates air from a space in the suction pad and depressurizes the space. By doing so, the suction pad sticks by suction to the desk D. The state in the suction pad is not limited to a vacuum state. The suction part 13 may set the pressure in the suction pad to be negative pressure so that the suction pad is not easily removed from the desk D. The vacuum sensor detects the degree of vacuum in the suction pad. The vacuum sensor detects the degree of vacuum in the suction pad at predetermined time intervals and outputs a result of the detection to the suction control unit 16.

Some stores such as a cafe where people work remotely may not have a desk leg around which the above-described security wire can be wound. In such a store, anti-theft measures using a wire cannot be taken. On the other hand, the suction device 1 can be firmly fixed to a desk or the like of a store by means of the suction part 13, and therefore anti-crime measures can be taken regardless of whether or not a desk leg is available.

Further, even when a desk leg around which a wire can be wound is available, it is troublesome for a user to wind a wire and perform locking each time when leaving his/her seat. In contrast, the suction device 1 can stick by suction to a desk or the like through the suction part 13, so that a user does not need to perform troublesome operations, such as winding a wire and performing locking.

Further, a wire may be cut by a nipper or the like. In contrast, the suction device 1 does not include a wire, and thus there is no possibility that the mobile device 2 will be stolen by cutting a wire.

The notification unit 14 sends a notification in accordance with the control of the notification control unit 18. The notification unit 14 may be a sound output apparatus which outputs sound information for sending a notification. The sound output apparatus may be, for example, a speaker or a buzzer. The notification unit 14 may include a display apparatus which outputs display information for sending a notification. The display apparatus may be, for example, a display or a lamp. For example, the notification unit 14 may output light using a Light Emitting Diode (LED) or the like. The notification unit 14 may send a notification by using both sound and light.

The battery unit 15 includes a battery for storing electric power for operating a vacuum pump, electric power for operating a vacuum sensor, and electric power for outputting sound or the like. The battery unit 15 supplies electric power to each unit.

Although the battery unit 15 is preferably a rechargeable lithium ion battery, it may be a secondary battery other than the lithium ion battery or a primary battery such as a dry battery. Alternatively, when the mobile device 2 has a function as a wireless charger, the suction device 1 may have a wireless charging reception function. It is also possible to perform sticking by supplying electric power from the mobile device 2 to the suction device 1 through USB without providing a battery in the suction device 1. However, this method is not preferably used, because the power supply may be cut off by a third person and hence sticking may be released.

The suction control unit 16 controls the ON/OFF of the sticking operation of the suction part 13 by controlling the vacuum pump and the vacuum sensor. The suction control unit 16 acquires a result of the detection from the vacuum sensor and monitors the degree of vacuum in the suction pad.

When the desk D has irregularities, air enters through a gap between the suction pad and the desk D, and hence the degree of vacuum in the suction pad gradually decreases. When the degree of vacuum decreases, the suction control unit 16 controls the vacuum pump so as to remove air again from the space in the suction pad. The suction control unit 16 may determine whether or not the degree of vacuum decreases by using a predetermined threshold.

As described above, by monitoring the degree of vacuum in the suction pad, the suction control unit 16 maintains the state in which the suction device 1 is sticking by suction to the desk D. Therefore, the suction control unit 16 can maintain the state in which the suction device 1 is sticking by suction to the desk D even when the desk D is made of wood or the like and has thus some irregularities. Therefore, as long as the top surface of the desk D is reasonably flat, the desk D may be made of any material.

The suction control unit 16 performs the ON/OFF control of the sticking operation through the communication unit 11 of the suction device 1 and a communication unit 21 of the mobile device 2. For example, a user transitions the mobile device 2 to a sleep state when leaving his/her seat. The mobile device 2 is configured to disconnect communication with the suction device 1 by transitioning to a sleep state. The suction control unit 16 detects that the wireless communication is disconnected when the mobile device 2 transitions to a sleep state. At this time, the suction control unit 16 turns ON the sticking operation of the suction part 13.

After that, when the user has returned to his/her seat and then logged in to the mobile device 2, the suction control unit 16 receives a notification from the mobile device 2 that the user has logged in. At this time, the suction control unit 16 turns OFF the sticking operation of the suction part 13. The trigger for turning ON/OFF the sticking operation is not limited thereto. The suction control unit 16 may turn ON/OFF the sticking operation through, for example, an operation from an application on the mobile device 2. The user may perform input for turning ON/OFF the sticking operation through an input unit (not shown) provided in the mobile device 2. The input unit is, for example, a keyboard, a mouse, or a touch panel.

The theft determination unit 17 determines whether or not the mobile device 2 is in a stolen state based on a sticking state of the suction part 13. The sticking state indicates a state in which the suction part 13 is sticking by suction to the desk D. The sticking state includes a degree of strength with which the suction part 13 sticks by suction to the desk D. The sticking state may be determined based on a result of the detection by the vacuum sensor provided in the suction part 13. As the sticking state, the strength with which the suction part 13 sticks by suction may be expressed by a numerical value or a level. Further, the sticking state may be expressed by a status such as "sticking by suction", "not sticking by suction", "strongly sticking by suction", or "weakly sticking by suction". The stolen state indicates a state in which the mobile device 2 is stolen. The stolen state includes a state in which the mobile device 2 is about to be stolen.

The theft determination unit 17 determines whether or not the mobile device 2 is in a stolen state based on a speed at which the sticking state is changed. The change speed indicates the amount of change in the sticking state per unit time. When the sticking is removed by a third person with a strong force while the suction device 1 is sticking by suction to the desk D, the degree of vacuum measured by the vacuum sensor rapidly decreases.

For example, the theft determination unit 17 determines that the mobile device 2 is in a stolen state when the speed at which the degree of vacuum in the suction pad decreases is equal to or greater than a predetermined threshold. In the following description, the predetermined threshold may be referred to as a "vacuum degree decrease speed threshold". The vacuum degree decrease speed threshold may be set in advance.

The theft determination unit 17 may determine whether or not the mobile device 2 is in a stolen state by using a vibration sensor instead of the vacuum sensor. The theft determination unit 17 may determine that the mobile device 2 is in a stolen state when it detects the magnitude of the vibration equal to or larger than a predetermined threshold. The theft determination unit 17 may use both the vacuum sensor and the vibration sensor.

The notification control unit 18 sends a notification when the theft determination unit 17 determines that the mobile device 2 is in a stolen state. Specifically, the notification control unit 18 controls the notification unit 14 to send a notification. For example, the notification control unit 18 causes the notification unit 14 to output a loud alert. By doing so, the notification control unit 18 can send a notification to a third person who attempts to steal the mobile device 2 and people near the third person.

Further, when a user, who has returned to his/her seat, has logged in to the mobile device 2, the notification control unit 18 receives a notification from the mobile device 2 that the user has logged in. When an alert is being output while the user is away from his/her seat, the notification control unit 18 stops the alert. The notification control unit 18 may stop the alert by receiving from the user an input indicating that the output of the alert is to be stopped. Thus, the user can stop the alert manually.

### Mobile Device 2

The mobile device 2 includes the communication unit 21 and a user authentication unit 22. Like the suction device 1, the mobile device 2 includes, as components that are not shown, a processor, a memory, and a storage device (not shown). The processor loads a computer program from the storage device into the memory and executes the loaded computer program, thereby implementing the function of the user authentication unit 22.

The communication unit 21 communicates with the suction device 1. Like the communication unit 11, the communication unit 21 is a communication interface for performing wireless communication by a communication scheme such as Bluetooth. The communication unit 21 may communicate with the suction device 1 by wired communication.

The user authentication unit 22 authenticates a user. The user authentication unit 22 determines whether or not a user, who has left his/her seat, has returned to his/her seat based on a result of the authentication. The user authentication unit 22, for example, detects that the user has logged in to the mobile device 2. The mobile device 2 may authenticate the user by using password authentication or biometric authentication. Upon successful authentication, the user authentication unit 22 detects that the user has logged in to the mobile device 2.

Upon successful authentication, the user authentication unit 22 determines that the user has returned to his/her seat. The user authentication unit 22 notifies the suction device 1 that the user has returned to his/her seat. In the suction device 1, the suction control unit 16 receives the notification and controls the sticking operation. Upon failed authentication, the user authentication unit 22 may detect that a third person has attempted to log in.

Although the configuration of the suction system 100 has been described above, the configuration of the suction system 100 is not limited to the above-described configuration. For example, the suction system 100 may have a configuration in which the suction device 1 and the desk D are firmly fixed to each other by means of a strong double-sided tape or the like, to thereby make the suction device 1 stick by suction to the mobile device 2. For example, this configuration may be used when the suction device 1 is not intended to be moved from the desk D.

### Processing of Suction Device 1

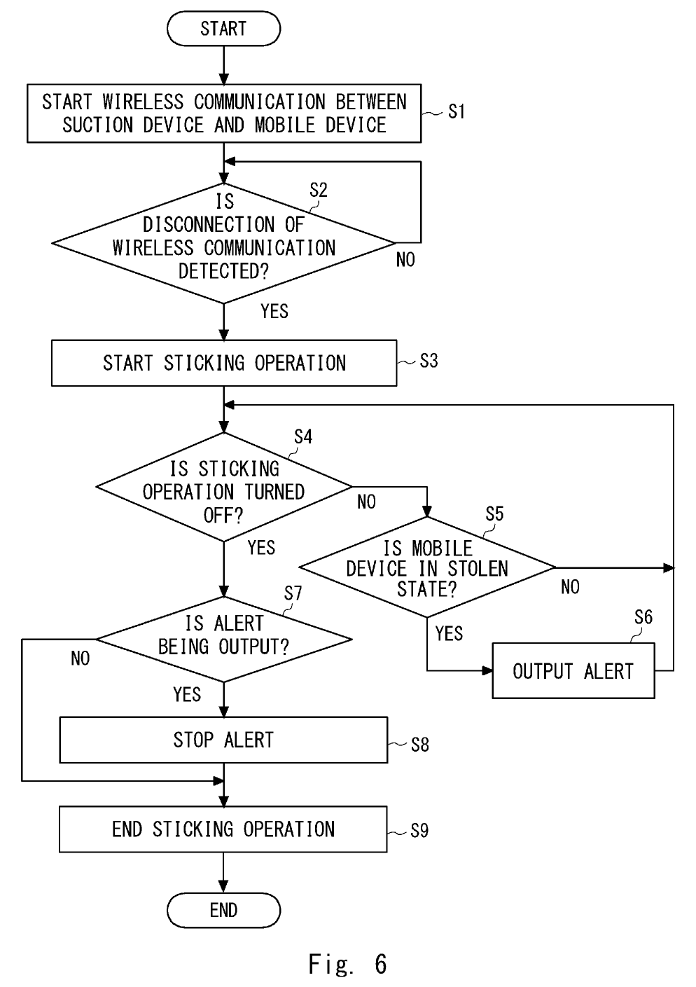

Next, processes performed by the suction device 1 will be described with reference to FIG. 6. FIG. 6 is a flowchart showing the processes performed by the suction device 1. First, the communication unit 11 starts wireless communication between the suction device 1 and the mobile device 2 (S1). Note that the communication unit 11 may perform wired communication instead of wireless communication.

Next, the suction control unit 16 determines whether or not disconnection of the wireless communication is detected (S2). For example, the suction control unit 16 detects disconnection of the wireless communication if the mobile device 2 transitions to a sleep state when a user leaves his/her seat.

When the suction control unit 16 determines that disconnection of the wireless communication is not detected (NO in S2), the suction control unit 16 repeats the process of Step S2. When the suction control unit 16 determines that disconnection of the wireless communication is detected (YES in S2), the suction control unit 16 starts the sticking operation (S3). The suction control unit 16 removes air in the suction pad by using the vacuum pump of the suction part 13. By doing so, the suction device 1 sticks by suction to the desk D. The suction control unit 16 monitors the degree of vacuum in the suction pad by the vacuum sensor, and when the degree of vacuum is reduced, the suction control unit 16 removes air again from the space in the suction pad, thereby maintaining the state in which the suction device 1 is sticking by suction to the desk D.

Next, the suction control unit 16 determines whether or not the sticking operation is turned OFF (S4). For example, when a user has returned to his/her seat and then logged in to the mobile device 2, the suction control unit 16 receives a notification from the mobile device 2 that the user has logged in, and turns OFF the sticking operation. The suction control unit 16 may turn OFF the sticking operation through, for example, an operation from an application on the mobile device 2.

When it is determined that the sticking operation is not turned OFF (NO in S4), the theft determination unit 17 determines whether or not the mobile device 2 is in a stolen state (S5). The theft determination unit 17 determines whether or not the mobile device 2 is in a stolen state based on the sticking state of the suction part 13. For example, the theft determination unit 17 determines that the mobile device 2 is in a stolen state when the speed at which the degree of vacuum in the suction pad decreases is equal to or greater than a predetermined vacuum degree decrease speed threshold.

When it is determined that the mobile device 2 is not in a stolen state (NO in S5), the suction device 1 returns to Step S4 and repeats the process. When it is determined that the mobile device 2 is in a stolen state (YES in S5), the notification control unit 18 outputs an alert (S6). For example, the notification control unit 18 causes the notification unit 14 to output a loud alert. Further, the suction device 1 returns to Step S4 and repeats the process.

When it is determined that the sticking operation is turned OFF (YES in S4), the notification control unit 18 determines whether or not an alert is being output (S7). When it is determined that no alert is being output (NO in S7), the suction control unit 16 ends the sticking operation (S9). When it is determined that an alert is being output (YES in S7), the notification control unit 18 stops the alert (S8). Further, the suction control unit 16 ends the sticking operation (S9).

Note that, although a method in which the suction control unit 16 starts the sticking operation when disconnection of the wireless communication is detected in Step S2 has been described above, the present disclosure is not limited thereto. The suction control unit 16 may perform the sticking operation not only while a user is away from his/her seat but also at all times. By doing so, even when disconnection of the wireless communication is not detected for some reason, the theft determination unit 17 can determine whether or not the mobile device 2 is in a stolen state. Further, when the mobile device 2 is a small device such as a smartphone, there is a high possibility that the mobile device 2 will be stolen even while a user is at his/her seat. In such a case as well, theft can be prevented by making the suction device 1 stick by suction to the desk D at all times.

As described above, in the suction system 100 according to this embodiment, the suction device 1 firmly fixes the suction device 1 to the mobile device 2 at the firmly-fixing part 12. The suction part 13 makes the suction device 1 stick by suction to an object. For example, the suction part 13 makes the suction device 1 stick by suction to an object by means of a suction pad which sticks by vacuum suction to the object. The theft determination unit 17 determines whether or not the mobile device 2 is in a stolen state based on the sticking state of the suction part 13. For example, the theft determination unit 17 determines that the mobile device is in a stolen state when the speed at which the degree of vacuum in the suction pad decreases is equal to or greater than a predetermined threshold. The notification control unit 18 sends a notification when it is determined that the mobile device 2 is in a stolen state.

By the above configuration, when the mobile device 2 is about to be forcibly removed from an object, the suction device 1 can output an alert to its surroundings. Therefore, the suction system 100 can reduce the risk of the mobile device 2 being stolen.

### Second Embodiment

Next, a suction system 100a according to a second embodiment will be described. The suction system 100a according to this embodiment is an example in which a sticking method in the first embodiment is changed to sticking using a magnet.

The configuration of the suction system 100a is substantially similar to that of the suction system 100 shown in FIGS. 1 and 5, and the illustration thereof will thus be omitted. The configuration of the suction system 100a can be described by replacing the suction system 100 shown in FIGS. 1 and 5 by the suction system 100a. The suction system 100a includes the suction device 1 and the mobile device 2.

In the following description, differences between this embodiment and the first embodiment are focused on, and redundant descriptions will be omitted as appropriate. This embodiment differs from the first embodiment mainly in the configurations of the suction part 13 and the suction control unit 16 and a method for determining a stolen state in the theft determination unit 17.

The suction part 13 includes a magnet which magnetically sticks by suction to an object. It is assumed here that the object includes a magnetic substance. In this embodiment, a description will be given in accordance with the assumption that the material of the top plate of the desk D on which the mobile device 2 is placed is a magnetic substance or that a magnetic substance is embedded in the top plate. The magnet may be an electromagnet or a permanent magnet. In the following description, an example in which the suction part 13 includes an electromagnet is focused on.

The suction part 13 includes an iron core, a coil, and a magnetic sensor. The coil is wound around the axial center of the iron core. The suction part 13 generates a magnetic field by passing a current through the coil in accordance with the control of the suction control unit 16. By doing so, the coil functions as an electromagnet. The suction part 13 magnetically sticks by suction to the desk D.

The magnetic sensor detects a change in the magnetic field generated by the magnet. The magnetic sensor detects a change in the magnetic field at predetermined time intervals and outputs a result of the detection to the suction control unit 16. The magnetic sensor is, for example, a Hall sensor. The magnetic sensor is not limited thereto, and may instead be an MR sensor or the like.

The suction control unit 16 performs control so that a current flows through the coil of the suction part 13. The suction control unit 16 controls the ON/OFF of the sticking operation of the suction part 13 by controlling energization of the coil. The suction control unit 16 acquires a result of the detection from the magnetic sensor and monitors a change in the magnetic field generated by the electromagnet.

Like in the first embodiment, the theft determination unit 17 determines whether or not the mobile device 2 is in a stolen state based on the speed at which the sticking state is changed. In this embodiment, the theft determination unit 17 determines that the mobile device 2 is in a stolen state when the speed at which the magnetic field generated by the magnet is changed is equal to or greater than a predetermined threshold. In the following description, the predetermined threshold may be referred to as a "magnetic field change speed threshold". The magnetic field change speed threshold may be set in advance.

While the suction device 1 is sticking by suction to the desk D, the magnetic field generated by the electromagnet is not substantially changed. In contrast, when the sticking is removed by a third person with a strong force, the magnetic field measured by the Hall sensor is rapidly changed. For example, when the mobile device 2 is about to be removed from the desk D, the distance between the suction device 1 and the desk D increases, so that the strength of the magnetic field rapidly decreases. The theft determination unit 17 determines that the mobile device 2 is in a stolen state when the speed at which the magnetic field is changed becomes equal to or greater than the magnetic field change speed threshold.

The processes performed by the suction device 1 in this embodiment are similar to those in the first embodiment described with reference to FIG. 6, and the descriptions thereof will thus be omitted.

Note that, in the above description, a method in which an electric current is made to flow through the coil when the suction part 13 makes the suction device 1 to stick by suction to the desk D has been described. However, the present disclosure is not limited thereto. For example, the suction part 13 may include both an electromagnet and a permanent magnet, and may be configured to perform sticking by suction at all times using the permanent magnet. In this case, the suction part 13 first makes the suction device 1 stick by suction to the desk D using the permanent magnet. The suction part 13 magnetizes the iron core in a direction in which it repels the permanent magnet by passing an electric current through the coil. By doing so, the suction part 13 releases the sticking by suction using the permanent magnet. In this way, the suction device 1 can save the power consumption required for the sticking by suction.

### Third Embodiment

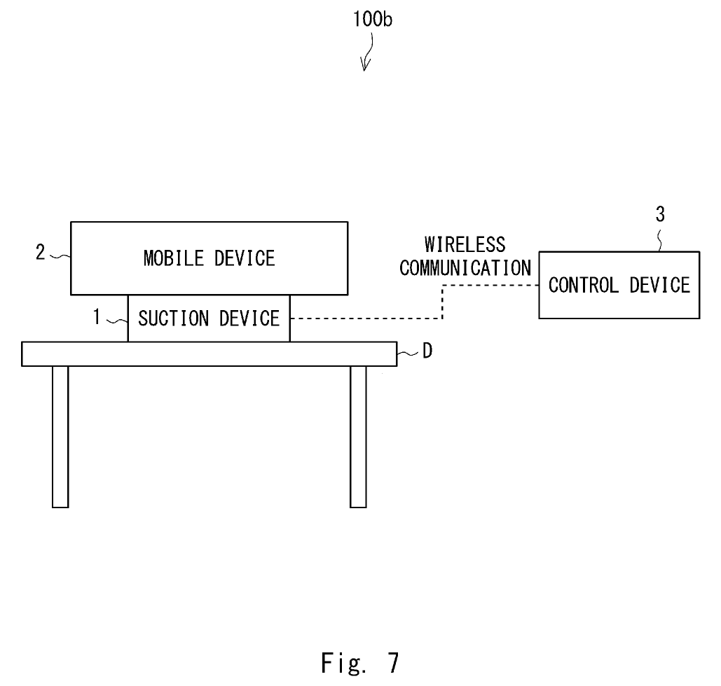

Next, a suction system 100b according to a third embodiment will be described. FIG. 7 is a diagram showing an overall configuration of the suction system 100b according to this embodiment. In the suction system 100b, a control device 3 for performing the ON/OFF control of the sticking operation of the suction device 1 is provided separately from the mobile device 2. Like the suction device 1 and the mobile device 2, the control device 3 is a device used by a user. In the following description, differences between this embodiment and the first embodiment are focused on, and redundant descriptions will be omitted as appropriate.

In the suction system 100b, communication is not performed between the suction device 1 and the mobile device 2, and wireless communication is performed only between the suction device 1 and the control device 3. Note that like in the first embodiment, wired communication may be performed instead of wireless communication.

When a user leaves his/her seat temporarily, the control device 3 turns ON the sticking operation of the suction device 1 to make the suction device 1 stick by suction to the desk D. The user leaves his/her seat while carrying the control device 3. It is assumed that the sticking is about to be forcibly removed while the sticking operation is ON. In this case, the suction device 1 detects that the sticking of the suction device 1 is about to be forcibly removed by a sensor or the like and issues an alert sound or the like to its surroundings. By doing so, it is possible to prevent a third person from turning OFF the sticking operation of the suction device 1.

In this embodiment, the mobile device 2 is not related to the control of the sticking operation. The operation performed by the mobile device 2 in the first embodiment is performed by the control device 3. This embodiment differs from the first embodiment mainly in communication means and a trigger for turning ON/OFF the sticking operation of the suction device 1.

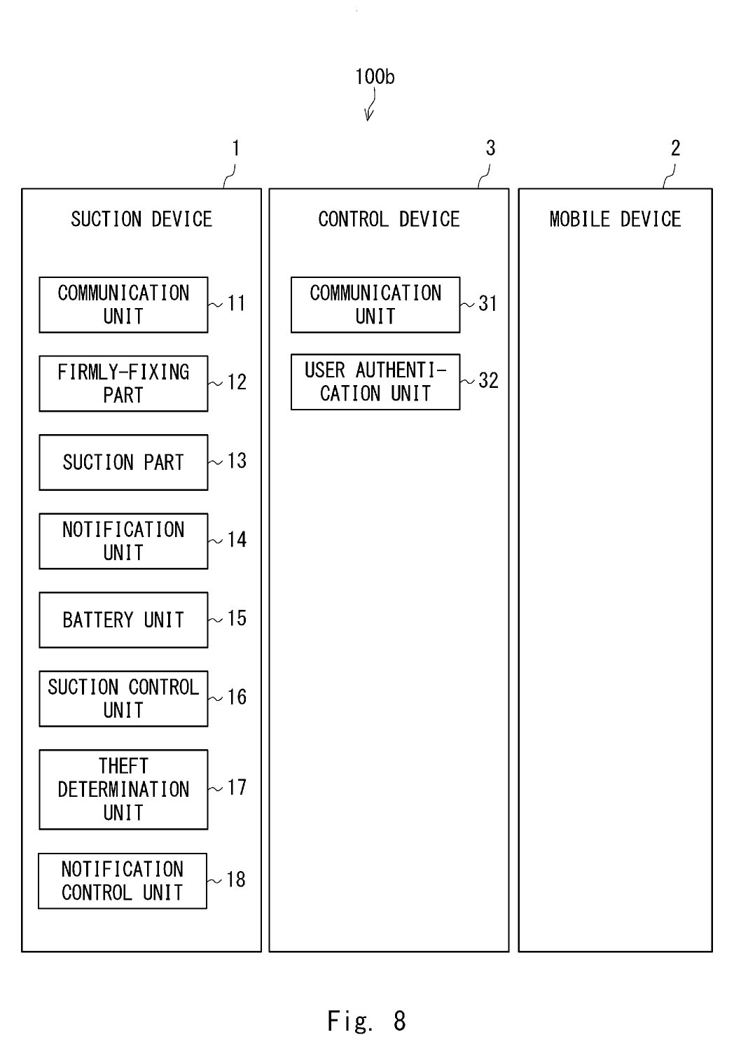

A configuration of the suction system 100b will be described in detail with reference to FIG. 8. FIG. 8 is a block diagram showing in detail the configuration of the suction system 100b. In this embodiment, like in the first embodiment, a description will be given of an example in which the suction device 1 sticks by suction to the desk D using an electrically-driven suction pad. Further, a notebook PC will be used as an example of the mobile device 2, and a smartphone will be used as an example of the control device 3. The control device 3 controls the suction device 1 to make the suction device 1 stick by suction to the desk D. By doing so, the mobile device 2 sticks by suction to the desk D through the suction device 1.

### Suction Device 1

Like in the first embodiment, the suction device 1 includes the communication unit 11, the firmly-fixing part 12, the suction part 13, the notification unit 14, the battery unit 15, the suction control unit 16, the theft determination unit 17, and the notification control unit 18. However, the suction control unit 16 has a function different from that in the first embodiment.

When the suction system 100b is used, a user leaves his/her seat while carrying the control device 3. When the suction device 1 is located more than a predetermined distance away from the control device 3, the connection between the suction device 1 and the control device 3 is lost.

The suction control unit 16 detects that the connection between the suction device 1 and the control device 3 is lost, and turns ON the sticking operation of the suction part 13. When the user has returned to his/her seat, the connection between the suction device 1 and the control device 3 is restored. The suction control unit 16 detects that the connection is restored, and turns OFF the sticking operation of the suction part 13.

The suction device 1 and the control device 3 communicate with each other through their wireless communication units using, for example, Bluetooth. The communication means between the suction device 1 and the control device 3 is not limited thereto, and may instead be, for example, NFC. When NFC is used, the communication unit 11 performs communication between the suction device 1 and the control device 3 at predetermined time intervals. In this case, it is desirable that the suction control unit 16 control the sticking so that the sticking operation of the suction part 13 is turned OFF when the communication is successfully performed, and the sticking operation is turned ON when the communication fails a predetermined number of times or more.

This is because NFC has a shorter range in which communication can be performed than Bluetooth. The range of NFC in which communication can be performed is generally about 10 cm at the maximum. Therefore, when the sticking operation is turned ON each time communication fails, the suction control unit 16 may turn ON the sticking operation by a user simply holding the control device 3 in his/her hand. In this case, it is considered that ON and OFF of the sticking operation are repeated frequently. Therefore, the suction control unit 16 performs control so that the sticking operation is turned ON when the number of communication failures reaches a predetermined number.

### Mobile Device 2

The description of a configuration of the mobile device 2 will be omitted. Like in the first embodiment, the mobile device 2 may include the communication unit 21 and the user authentication unit 22.

### Control Device 3

The control device 3 includes a communication unit 31 and a user authentication unit 32. The communication unit 31 and the user authentication unit 32 correspond to the communication unit 21 and the user authentication unit 22 of the mobile device 2 in the first embodiment, respectively. Therefore, detailed descriptions thereof will be omitted here.

### Processing of Suction Device 1

Since processes performed by the suction device 1 in this embodiment are substantially similar to those performed by the suction device 1 in the first embodiment shown in FIG. 6, the illustration thereof will be omitted and the differences between this embodiment and the first embodiment will be described.

As described above, in this embodiment, the control device 3 performs the processes performed by the mobile device 2 in the first embodiment. Therefore, for example, in Step S1, the communication unit 11 starts wireless communication between the suction device 1 and the control device 3. Further, in Step S2, when the suction device 1 is located more than a predetermined distance away from the control device 3, the suction control unit 16 detects that the connection between the suction device 1 and the control device 3 is lost. Consequently, the suction control unit 16 determines whether or not disconnection of the wireless communication is detected.

Further, in Step S4, when the connection between the suction device 1 and the control device 3 is restored, the suction control unit 16 determines whether or not the sticking operation is turned OFF. The processes performed by the suction device 1 according to this embodiment other than those described above can be implemented by performing the corresponding processes in the first embodiment.

As described above, the suction system 100b according to this embodiment includes the control device 3 different from the mobile device 2, and the control device 3 controls the sticking operation of the suction device 1. By this configuration, it is possible to prevent a third person from operating the mobile device 2 to turn OFF the sticking operation of the suction device 1 while a user is away from his/her seat. Thus, the suction system 100b can further reduce the risk of the mobile device 2 being stolen.

Each of the functional components of the suction device 1, the mobile device 2, and the control device 3 described above may be implemented by hardware (e.g., a hard-wired electronic circuit) for implementing the functional components, or may be implemented by a combination of hardware and software (e.g., a combination of an electronic circuit and a program for controlling the electronic circuit). For example, the present disclosure may also be implemented by causing a CPU to execute a computer program for any processing.

A combination of the third embodiment and the second embodiment may also be used. That is, in the third embodiment, like in the second embodiment, a sticking method may be changed to a sticking method using a magnet.

### Fourth Embodiment

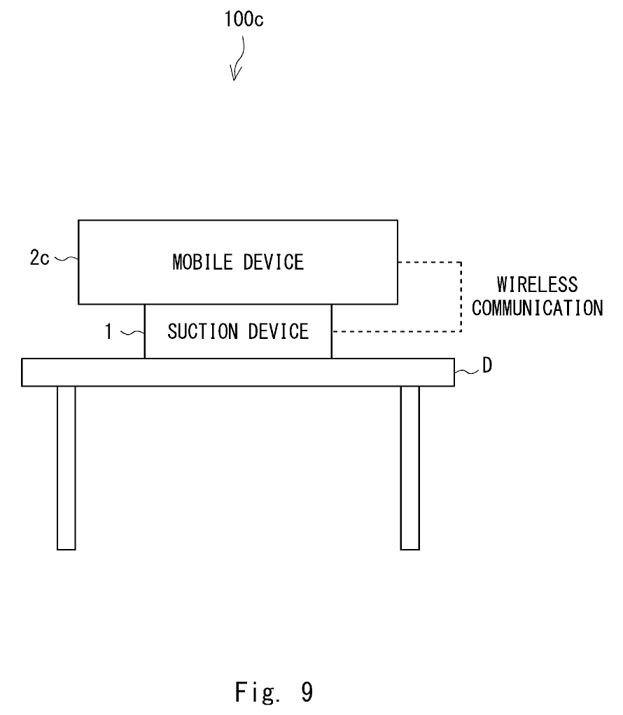

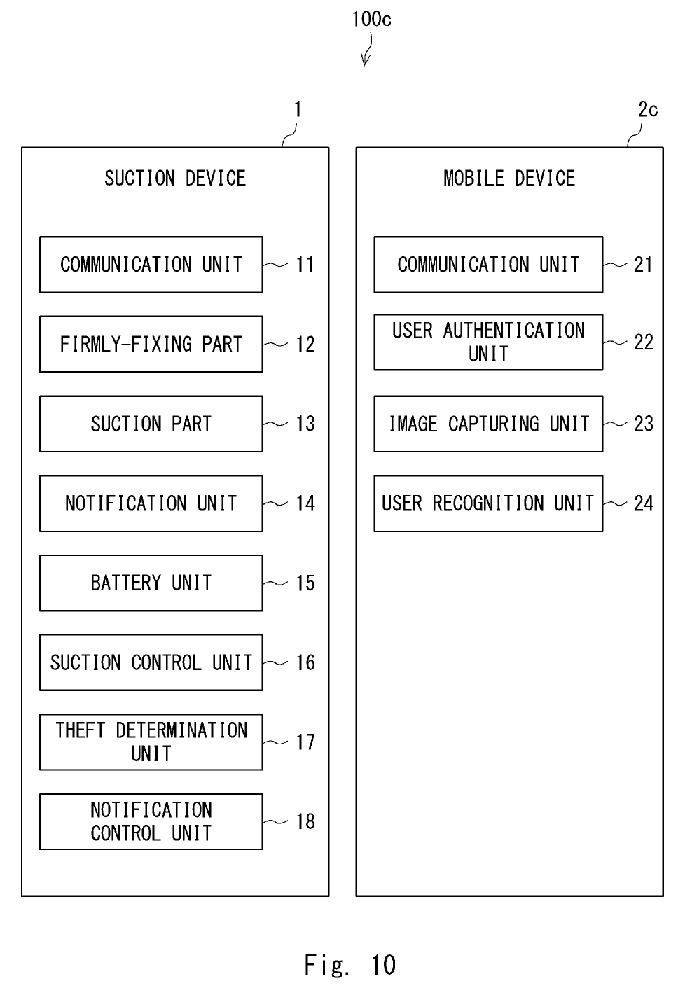

A suction system 100c according to a fourth embodiment will be described with reference to FIGS. 9 and 10. FIG. 9 is a diagram showing an overall configuration of the suction system 100c according to this embodiment. FIG. 10 is a block diagram showing in detail a configuration of the suction system 100c. The suction system 100c includes a mobile device 2c instead of the mobile device 2 of the suction system 100. As compared to the mobile device 2, the mobile device 2c further includes an image capturing unit 23 and a user recognition unit 24. In the following description, differences between this embodiment and the first embodiment are focused on, and redundant descriptions will be omitted as appropriate.

The mobile device 2c includes the image capturing unit 23 at a position where an image of the face of a user can be captured. The user recognition unit 24 stores a face image captured when the user authentication unit 22 authenticates a user as the face of the user and compares the stored face information with a result (an image) captured by the image capturing unit 23, thereby recognizing the user. After that, the user recognition unit 24 determines whether or not the user can be recognized from the result of the image capturing by the image capturing unit 23 each predetermined time. When the user recognition unit 24 determines that the user cannot be recognized, it notifies the suction control unit 16 that the user cannot be recognized through the communication unit 21 of the mobile device 2c and the communication unit 11 of the suction device 1.

The suction control unit 16 controls the ON/OFF of the sticking operation of the suction part 13 based on a result of the image capturing by the image capturing unit 23 provided in the mobile device 2c. When the suction control unit 16 receives the notification that the user cannot be recognized, it turns ON the sticking operation of the suction part 13. By the above configuration, the suction control unit 16 can automatically turn ON the sticking operation of the suction part 13 even if a user forgets to transition the mobile device 2c to a sleep state when leaving his/her seat.

The user recognition unit 24 determines whether or not a user can be recognized, for example, every second, and notifies the suction control unit 16 that the user cannot be recognized when it determines that the user cannot be recognized continuously for five seconds. By doing so, it is possible to avoid an unnecessary sticking operation performed, for example, when a user turns his/her face away from the mobile device 2c for a short period of time.

The user recognition unit 24 may detect that a user is dozing based on a result of the image capturing by the image capturing unit 23. When the user recognition unit 24 detects that the user is dozing, the user recognition unit 24 notifies the suction control unit 16 that it detects that the user is dozing. When the suction control unit 16 receives the notification that it is detected that the user is dozing, the suction control unit 16 turns ON the sticking operation of the suction part 13. By the above configuration, even when a user dozes, the suction control unit 16 can automatically turn ON the sticking operation of the suction part 13.

### Fifth Embodiment

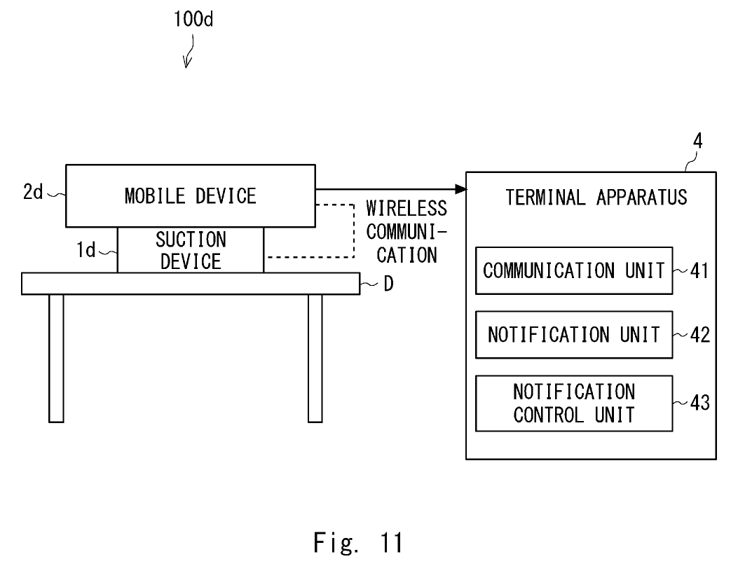

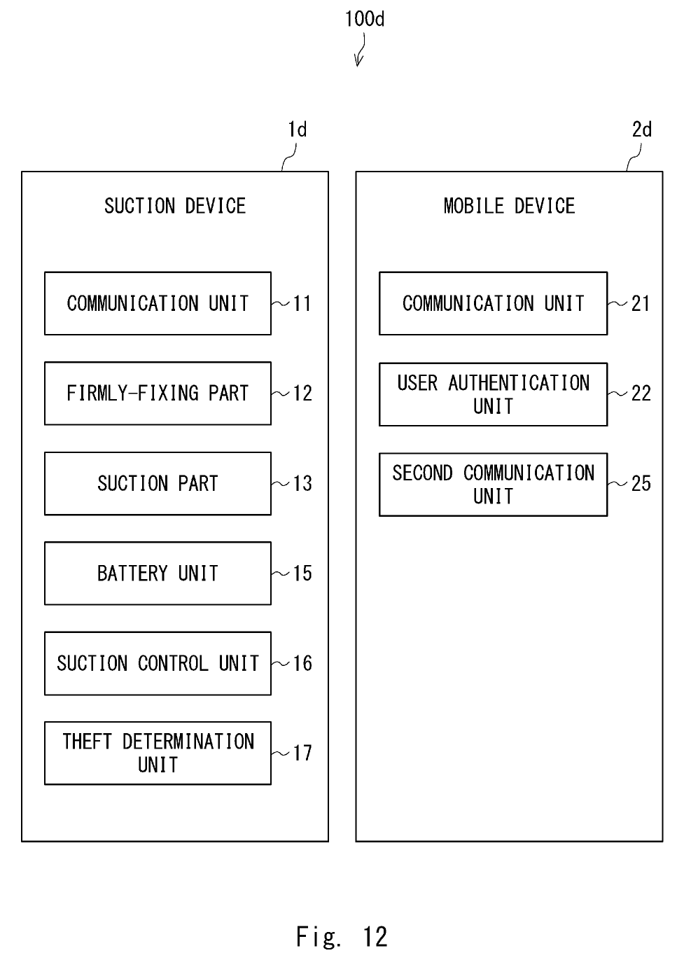

A suction system 100d according to a fifth embodiment will be described with reference to FIGS. 11 and 12. FIG. 11 is a diagram showing an overall configuration of the suction system 100d according to this embodiment. FIG. 12 is a block diagram showing in detail a configuration of the suction system 100d. The suction system 100d includes a suction device 1d and a mobile device 2d instead of the suction device 1 and the mobile device 2 of the suction system 100. The suction system 100d further includes a terminal apparatus 4 which receives a notification that the mobile device 2d is in a stolen state. The terminal apparatus 4 is a communication device such as a smartphone carried by a user.

The suction device 1d does not include the notification unit 14 and the notification control unit 18 included in the suction device 1. The mobile device 2d further includes a second communication unit 25 as compared to the mobile device 2. The second communication unit 25 is a communication interface for performing wireless communication by a communication scheme such as Wi-Fi (registered trademark). The terminal apparatus 4 includes a communication unit 41, a notification unit 42, and a notification control unit 43. The communication unit 41 is a communication interface for performing wireless communication by a communication scheme such as Wi-Fi (registered trademark). The communication unit 41 communicates with the second communication unit 25 of the mobile device 2d. In the following description, differences between this embodiment and the first embodiment are focused on, and redundant descriptions will be omitted as appropriate.

When the theft determination unit 17 of the suction device 1d determines that the mobile device 2d is in a stolen state, it notifies the second communication unit 25 of the mobile device 2d that the mobile device 2d is in a stolen state through the communication unit 11 of the suction device 1d and the communication unit 21 of the mobile device 2d. The second communication unit 25 of the mobile device 2d transfers the received notification that the mobile device 2d is in a stolen state to the communication unit 41 of the terminal apparatus 4, which is a preset transfer destination.

When the communication unit 41 of the terminal apparatus 4 receives the notification that the mobile device 2d is in a stolen state, the communication unit 41 notifies the notification control unit 43 about it. The notification unit 42 sends a notification in accordance with the control of the notification control unit 43. The notification unit 42 may be a sound output apparatus for outputting sound information for sending a notification. The sound output apparatus may be, for example, a speaker or a buzzer. The notification unit 42 may include a display apparatus which outputs display information for sending a notification. The display apparatus may be, for example, a display or a lamp. For example, the notification unit 42 may output light using a Light Emitting Diode (LED) or the like. The notification unit 42 may send a notification by using both sound and light.

According to the suction system 100d, it is possible to notify the terminal apparatus 4 carried by a user that the mobile device 2d is in a stolen state. Therefore, even when a user is in a location away from the suction device 1d and the mobile device 2d, he/she can know that the mobile device 2d is in a stolen state.

The program includes instructions (or software codes) that, when loaded into a computer, cause the computer to perform one or more of the functions described in the embodiments. The program may be stored in various types of non-transitory computer readable media or tangible storage media. By way of example, and not a limitation, non-transitory computer readable media or tangible storage media can include a Random-Access Memory (RAM), a Read-Only Memory (ROM), a flash memory, a Solid-State Drive (SSD) or other types of memory technologies, a CD-ROM, a Digital Versatile Disc (DVD), a Blu-ray (registered trademark) disc or other types of optical disc storage, a magnetic cassette, a magnetic tape, and a magnetic disk storage or other types of magnetic storage devices. Further, the program may be transmitted on various types of transitory computer readable media or communication media. By way of example, and not a limitation, transitory computer readable media or communication media can include electrical, optical, acoustical, or other forms of propagated signals.

Note that the present disclosure is not limited to the above-described embodiments and may be changed as appropriate without departing from the scope and spirit of the present disclosure. Further, the above embodiments may be implemented in any combination.

By the suction device and the suction system according to the present disclosure, it is possible to reduce the risk of a mobile device being stolen.

The present disclosure can be applied to, for example, a suction device and a suction system.

What is claimed is:

1. A suction device comprising:
a firmly-fixing part used to firmly fix a suction device to a mobile device;
a suction part used to make the suction device stick by suction to an object;
a theft determination unit configured to determine whether or not the mobile device is in a stolen state based on a sticking state of the suction part; and
a notification control unit configured to send a notification when it is determined that the mobile device is in a stolen state.

2. The suction device according to claim 1, wherein the theft determination unit determines whether or not the mobile device is in a stolen state based on a speed at which the sticking state is changed.

3. The suction device according to claim 2, wherein
the suction part comprises a suction pad configured to stick by vacuum suction to the object, and
the theft determination unit determines that the mobile device is in a stolen state when a speed at which a degree of vacuum in the suction pad decreases is equal to or greater than a predetermined threshold.

4. The suction device according to claim 2, wherein
the object includes a magnetic substance,
the suction part comprises a magnet configured to magnetically stick to the object, and
the theft determination unit determines that the mobile device is in a stolen state when a speed at which a magnetic field generated by the magnet is changed is equal to or greater than a predetermined threshold.

5. The suction device according to claim 1, further comprising:
a communication unit configured to communicate with the mobile device; and
a suction control unit configured to control a sticking operation of the suction part based on a result of image capturing by an image capturing unit provided in the mobile device.

6. A suction system comprising:
a mobile device; and
a suction device configured to make the mobile device stick by suction to an object,
wherein the suction device comprises:
a firmly-fixing part used to firmly fix the suction device to the mobile device;
a suction part used to make the suction device stick by suction to the object;
a theft determination unit configured to determine whether the mobile device is in a stolen state based on a sticking state of the suction part; and
a notification control unit configured to send a notification when the stolen state is determined.

7. The suction system according to claim 6, further comprising a notification unit of the suction device,
wherein the notification control unit causes the notification unit to output an alert.

8. The suction system according to claim 6,
wherein the suction device further comprises a communication unit configured to notify a terminal apparatus that the mobile device is in the stolen state through the mobile device.

9. A suction device comprising:
a firmly-fixing part used to firmly fix a suction device to a mobile device;
a suction part used to make the suction device stick by suction to an object;
a theft determination unit configured to determine whether or not the mobile device is in a stolen state based on a sticking state of the suction part; and
a communication unit configured to notify a terminal apparatus that the mobile device is in a stolen state through the mobile device when it is determined that the mobile device is in a stolen state.
